(19) United States
(12) Patent Application Publication
(10) Pub. No.: US 2026/0323210 A1
(43) Pub. Date: Oct. 15, 2026

(54) METHOD AND ELECTRONIC APPARATUS FOR CONTROLLING MEMBRANE EXCURSION

(71) Applicant: SAMSUNG ELECTRONICS CO., LTD., Suwon-si (KR)

(72) Inventors: Rishabh GUPTA, Bangalore (IN); Raj Narayana Gadde, Bangalore (IN); Beakkwon Son, Suwon-si (KR); Vadim Kudryavtsev, Suwon-Si (KR); Sandeep Agri, Bangalore (IN); Ayush Asthana, Bangalore (IN); Yughendaran Palanivel, Bangalore (IN); Omsrinath Chelamkuri, Bangalore (IN)

(73) Assignee: SAMSUNG ELECTRONICS CO., LTD., Suwon-si (KR)

(21) Appl. No.: 19/677,665

(22) Filed: May 14, 2026

Related U.S. Application Data
(63) Continuation of application No. PCT/KR2025/002884, filed on Mar. 4, 2025.

(30) Foreign Application Priority Data
Mar. 12, 2024 (IN) 202441017819
Feb. 7, 2025 (IN) 202441017819

(51) Int. Cl. H04R 3/00; H04R 3/04; H04R 29/00

(52) U.S. Cl. CPC H04R 3/007; H04R 3/002; H04R 3/04; H04R 29/001

(57) ABSTRACT

A method for membrane excursion control of an electronic apparatus includes receiving an audio signal input from at least one audio source, extracting at least one audio parameter derived from the audio signal input, inputting the at least one audio parameter into a distortion classifier to identify a first set of audio frames in the audio signal input causing audible distortion, and generating a first output, including a second set of distortionless audio frames, by inputting the first set of audio frames causing audio distortion into a plurality of speaker models. The at least one audio parameter includes at least one of: at least one speaker characteristic and at least one signal feature. The distortion classifier is trained using a synthetic audio dataset generated using a diffusion model with a loss function. The plurality of speaker models are artificial intelligent models trained using the synthetic audio dataset.

### CROSS-REFERENCE TO RELATED APPLICATIONS

This application is a Continuation Application of International Application No. PCT/KR2025/002884 filed on Mar. 4, 2025, which claims priority to Indian Provisional Patent Application No. 202441017819, filed on Mar. 12, 2024, at the Indian Intellectual Property Office and Indian Full Patent Application No. 202441017819, filed on Feb. 7, 2025, at the Indian Intellectual Property Office, the disclosures of which are incorporated herein in their entireties by reference.

### 1. FIELD

The present disclosure generally relates to the field of audio signal processing in electronic devices. More particularly, the present disclosure relates to a method and a system for membrane excursion control of a speaker device.

### 2. BACKGROUND OF THE RELATED ART

The increasing use of mobile devices for multimedia applications such as music playback, video calls, gaming, and podcasts has elevated the importance of micro-speakers in delivering immersive audio experiences. These compact electroacoustic transducers or the micro-speakers, typically measuring around 15 mm x 11 mm, are essential for providing sound output within the limited physical and power constraints of mobile devices. However, the micro-speakers face significant challenges due to their low power efficiency and the need to produce loud audio output with rich bass. To achieve these requirements, the micro-speaker diaphragm frequently operates beyond its linear range, leading to non-linear behavior. This non-linearity can introduce two major issues: audible distortions that degrade audio quality and mechanical damage to the diaphragm and surrounding components over time.

The operation of micro-speakers can be classified into linear, regular non-linear, and irregular non-linear modes. In linear mode, the diaphragm operates within safe displacement limits, maintaining sound quality with minimal distortion. Regular non-linear mode, which occurs at up to about 10% of the maximum rated displacement, involves deterministic behaviors such as changes in the spring constant and force factor, which are theoretically controllable. However, irregular non-linear mode, caused by larger displacements and/or manufacturing defects, results in semi-deterministic or stochastic behaviors like rub and buzz effects and airflow noise, which are harder to predict and control.

Existing methods for mitigating these issues typically rely on current-voltage (I-V) sensing and physical modelling of the speaker’s characteristics, but they face limitations. These include the need for complex hardware, sensitivity to model assumptions, and a focus primarily on speaker protection, often at the expense of audio quality in terms of timbre, loudness, and bass response. Despite advancements in adaptive control strategies, irregular non-linearities such as rub and buzz remain particularly challenging to address, highlighting the limitations of current approaches.

Traditional solutions in this domain include methods such as predicting the diaphragm amplitude of a micro-speaker based on an excitation signal and determining whether this amplitude exceeds a preset threshold. If the amplitude exceeds the present threshold, these methods apply a target adjustment gain via an equalizer algorithm to reduce the diaphragm amplitude below the threshold. This process aims to avoid airflow noise, prevent loudness fluctuations, and improve the efficiency of audio signal adjustment.

Additionally, other approaches utilize neural networks by inputting data samples of current and prior displacements of moving loudspeaker components into successive layers. These methods generate data vectors via nonlinear activation functions, transform these vectors through affine operations, and output predictions for the voltage required to control loudspeaker displacement. While these methods provide advanced techniques for managing speaker operation, they still face challenges in addressing irregular non-linear distortions and maintaining overall audio quality.

Therefore, in view of the above-mentioned problems, it is desirable to provide a system and a method that may eliminate, or at least, mitigate one or more of the above-mentioned problems associated with the existing solutions.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

This summary is provided to introduce a selection of concepts, in a simplified format, that are further described in the detailed description of the disclosure. This summary is neither intended to identify key or essential inventive concepts of the invention nor is it intended to determine the scope of the disclosure.

According to an aspect of the present disclosure, a method for membrane excursion control of an electronic apparatus is provided. The method may include receiving an audio signal input from at least one audio source. The method may include extracting at least one audio parameter derived from the audio signal input. The oat least one audio parameters may include at least one of: at least one speaker characteristic and at least one signal feature. The method may include inputting the at least one audio parameters into a distortion classifier to identify a first set of audio frames in the audio signal input causing audible distortion. The distortion classifier may be trained using a synthetic audio dataset generated using a diffusion model with loss function. The method may include generating a first output, including a second set of audio frames, by inputting the first set of audio frames causing audio distortion into a plurality of speaker models. The second set of audio frames may be distortion less. The plurality of speaker models may be artificial intelligent (AI) models trained using the synthetic audio dataset.

According to an aspect of the present disclosure, an electronic apparatus for controlling membrane excursion is provided. The apparatus may include a memory configured to store executable instructions, and at least one processor coupled to the memory and configured to execute the instructions may cause the device to receive an audio signal input from one or more audio sources. The at least one processor coupled to the memory and configured to execute the instructions may cause the device to extract at least one audio parameter derived from the audio signal input. The at least one audio parameter may include at least one of: at least one speaker characteristic and at least one signal feature. The at least one processor coupled to the memory and configured to execute the instructions may cause the device to input the at least one audio parameters into a distortion classifier to identify a first set of audio frames in the audio signal input causing audible distortion. The distortion classifier may be trained using a synthetic audio dataset generated using a diffusion model with a loss function. The at least one processor coupled to the memory and configured to execute the instructions may cause the device to generate a first output, including a second set of audio frames, by inputting the first set of audio frames causing audio distortion into a plurality of speaker models. The second set of audio frames may be distortion less. The plurality of speaker models may be artificial intelligent (AI) models trained using the synthetic audio dataset.

According to an aspect of the present disclosure, a non-transitory computer readable medium storing instructions, the instructions configured to cause one or more processors of a computer to perform a method for membrane excursion control of an electronic apparatus is provided. The method may include receiving an audio signal input from at least one audio source. The method may include extracting at least one audio parameter derived from the audio signal input. The at least one audio parameter may include at least one of: at least one speaker characteristic and at least one signal feature. The method may include inputting the oat least one parameter into a distortion classifier to identify a first set of audio frames in the audio signal input causing audible distortion. The distortion classifier may be trained using a synthetic audio dataset generated using a diffusion model with a custom loss function. The method may include generating a first output, including a second set of audio frames, by inputting the first set of audio frames causing audio distortion into a plurality of speaker models. The second set of audio frames may be distortion less. The plurality of speaker models may be artificial intelligent (AI) models trained using the synthetic audio dataset.

To further clarify the advantages and features of the present disclosure, a more particular description of the disclosure will be rendered by reference to specific embodiments thereof, which are illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF DRAWINGS

These and other features, aspects, and advantages of the present disclosure will become better understood when the following detailed description is read with reference to the accompanying drawings in which like characters represent like parts throughout the drawings, wherein:

FIG. 1 illustrates an architecture of a system for membrane excursion control of a speaker device, according to an embodiment of the present disclosure;

FIG. 2 illustrates a process-flow for generating a target audio using a diffusion model , according to an embodiment of the present disclosure;

FIG. 3A-3B illustrate a process-flow for training and inference of the distortion classifier, according to an embodiment of the present disclosure;

FIG. 4A illustrate a process-flow for training the first speaker model or the second speaker model, according to an embodiment of the present disclosure;

FIG. 4B illustrates a process-flow for inference of the first speaker model and the second speaker model, according to an embodiment of the present disclosure;

FIG. 5 illustrates a system for membrane excursion control of the speaker device according to an embodiment of the present disclosure; and

FIG. 6 illustrates a flowchart depicting a method for membrane excursion control of the speaker device, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments, and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

The term “some” or “one or more” as used herein is defined as “one”, “more than one”, or “all.” Accordingly, the terms “more than one,” “one or more” or “all” would all fall under the definition of “some” or “one or more”. The term “an embodiment”, “another embodiment”, “some embodiments”, or “in one or more embodiments” may refer to one embodiment or several embodiments, or all embodiments. Accordingly, the term “some embodiments” is defined as meaning “one embodiment, or more than one embodiment, or all embodiments.”

The terminology and structure employed herein are for describing, teaching, and illuminating some embodiments and their specific features and elements and do not limit, restrict, or reduce the spirit and scope of the claims or their equivalents. The phrase “exemplary” may refer to an example.

More specifically, any terms used herein such as but not limited to “includes,” “comprises,” “has,” “consists,” “have” and grammatical variants thereof do not specify an exact limitation or restriction and certainly do not exclude the possible addition of one or more features or elements, unless otherwise stated, and must not be taken to exclude the possible removal of one or more of the listed features and elements, unless otherwise stated with the limiting language “must comprise” or “needs to include”.

Whether or not a certain feature or element was limited to being used only once, either way, it may still be referred to as “one or more features”, “one or more elements”, “at least one feature”, or “at least one element.” Furthermore, the use of the terms “one or more” or “at least one” feature or element does not preclude there being none of that feature or element unless otherwise specified by limiting language such as “there needs to be one or more “ or “one or more element is required.”

Unless otherwise defined, all terms, and especially any technical and/or scientific terms, used herein may be taken to have the same meaning as commonly understood by one having ordinary skill in the art.

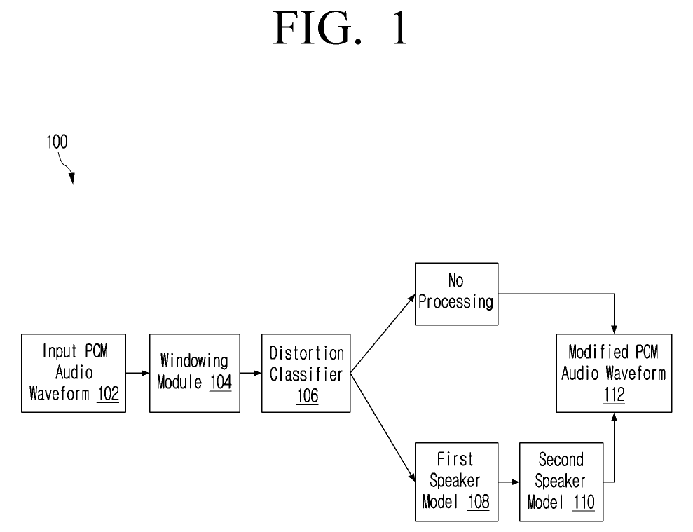

FIG. 1 illustrates an architecture 100 of a system for membrane excursion control of a speaker device, according to an embodiment of the present disclosure.

In an embodiment, the architecture 100 of the system for membrane excursion control of the speaker device may include, a windowing module 104 receiving an input PCM audio waveform 102, a distortion classifier 106, a first speaker model 108, and a second speaker model 110 producing a modified PCM audio waveform 112. In an embodiment, the first speaker model may be an ideal speaker model and the second speaker model may be an inverse speaker model.

In one embodiment, an input pulse code modulation (PCM) audio waveform 102 may be provided as an input to the windowing module 104. In one example the input PCM audio waveform 102 of an audio track played during a video call or music playback may be provided as input to the windowing module 104. The windowing module 104 may be configured to extract one or more audio parameters derived from the audio signal input. The one or more audio parameters may include one or more speaker characteristics and signal features. The speaker characteristics indicates a physical and acoustic characteristics of the speaker and the signal features include amplitude, frequency, a root mean square energy, and the like.

Upon extracting one or more audio parameters derived from the input PCM audio signal, the distortion classifier 106 may be configured to receive the extracted one or more audio parameters to identify a first set of audio frames in the audio signal input causing audible distortion. The first set of audio frames in the audio signal input causing audible distortion indicates one or more specific portions or segments (e.g. one or more audio frames) of the overall input PCM audio signal that may be responsible for producing noticeable, undesired sound distortions when played through the speaker.

Further, the distortion classifier 106 may be configured to evaluate the one or more audio parameters received from the windowing module 104 and consequently determine whether the one or more audio frames are likely to cause audible distortions based on measured speaker characteristics and signal features. The one or more audio parameters may include the one or more speaker characteristics, such as one or more physical and one or more acoustic characteristics of the speaker and the signal features such as amplitude, frequency, and the like. Furthermore, the distortion classifier 106 may be trained using a synthetic audio dataset generated using a diffusion model with a custom loss function. The synthetic audio dataset may be a type of audio dataset trained using synthetic data or duplicate data.

In an example, when a user plays a high-bass song on their smartphone at maximum volume, the distortion classifier 106 may be configured to analyze the incoming audio waveform to extract key parameters such as frequency content, amplitude, and transients. For example, the distortion classifier may detect that certain frames of the audio signal, such as the bass drops at 150 Hz, have high amplitude low-frequency components that could exceed the speaker’s excursion limits. The distortion classifier 106 may evaluate the one or more audio parameters and identify the bass-heavy frames as likely to cause audible distortion.

Upon identifying the first set of audio frames in the audio signal input causing audible distortion by the distortion classifier 106, the first speaker model 108 may be configured to generate a second output by receiving the identified first set of audio frames. Further, the second speaker model 110 may be configured to receive the second output from the first speaker model 108 to generate the first output i.e., modified PCM audio waveform 112. The modified PCM audio waveform 112 may include the a second set of audio frames which are distortion-less or distortion free audio frames.

Additionally, to generate a second output, the first speaker model 108 may be configured to determine an acoustic pressure of the identified first set of audio frames. The first speaker model 108 may then be configured to generate the second output based on the first set of audio frames. The second output indicates the determined acoustic pressure of the identified first set of audio frames.

The determined acoustic pressure of the first set of audio frames may refer to the variation in pressure caused by the sound waves generated by the audio signal, specifically for the frames identified as distortion-prone. When an audio signal drives the speaker, it produces mechanical vibrations in the speaker membrane, consequently creating sound waves in the surrounding air. These sound waves result in localized pressure changes, measured as acoustic pressure, which correspond to the perceived loudness and intensity of the sound. For the first set of audio frames, which are flagged for causing audible distortion, the acoustic pressure may be higher and often exhibits irregular behavior due to excessive displacement of the speaker membrane. This irregularity can lead to nonlinear responses, such as distorted or harsh sounds.

In an example, when a user streams a high-quality movie on a smartphone, the distortion classifier 106 may be configured to analyze the input audio signal to identify the first set of audio frames that may cause audible distortion, such as loud explosion effects with low-frequency components. The identified first set of audio frames may then be processed by the first speaker model 108, which may simulate the speaker’s ideal acoustic response and may generate the second output, which may represent the corrected version of the distortion-prone frames. The second output may subsequently be fed into the second speaker model 110, which may apply further refinement to match the actual speaker’s physical characteristics and may generate the distortion less modified PCM audio waveform 112.

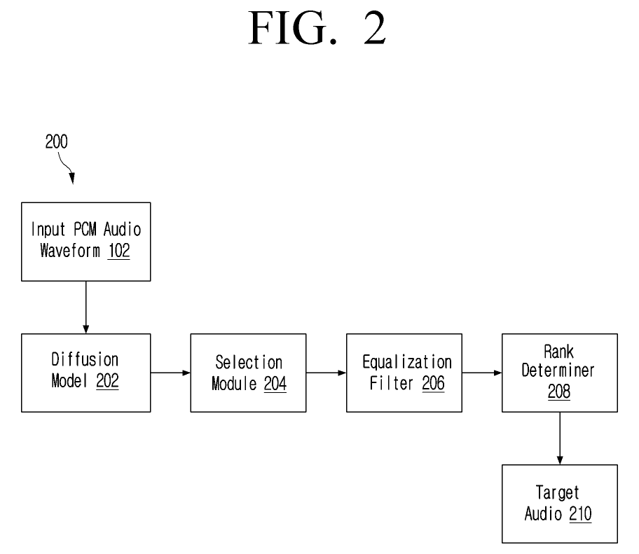

FIG. 2 illustrates a process-flow 200 for generating a target audio 210 using a diffusion model 202, according to an embodiment of the present disclosure.

In an embodiment, the input pulse code modulation (PCM) audio waveform 102 may be provided as an input to the diffusion model 202. The input PCM audio waveform 102 may generate various imperfections, such as distortions or artifacts, that affect the sound quality when played back over micro-speakers.

The diffusion model 202 may be trained specifically to generate high-quality audio waveforms which may not produce audible distortions over micro-speakers (e.g. the target audio 210) by iteratively refining the input PCM audio waveform 102. Further, custom loss functions may be introduced, which may be designed to measure audio quality metrics such as partial loudness, harmonic signal ratio errors, and distortion. The custom loss functions may enable the diffusion model 202 to minimize distortions while maximizing sound fidelity. The diffusion model may be a type of generative machine learning model designed to generate new data by learning the underlying distribution of a given dataset. The diffusion model may create high-quality images, audio, or other types of structured data.

The selection module 204 may be configured to select a second set of audio tracks based on audio quality metrics derived from the custom loss functions such that the identified second set of audio tracks may be free from distortion in terms of sound quality. The audio quality metrics may refer to measurable parameters or criteria used to evaluate the quality of the audio signals. The audio quality metrics may allow assessment of the audio characteristics such as clarity, fidelity, and absence of distortions. The examples of the audio quality metrics may include signal-to-noise ratio (SNR), total harmonic distortion (THD), spectral flatness, perceptual evaluation of audio quality (PEAQ), loudness, timbre, and the like.

Further, the method 200 may include inputting the selected second set of audio tracks to an equalization filter 206, wherein the equalization filter 206 may be configured to emulate a perceptual filter bank-inspired filter, with filter parameters adjustable by a user listening to the audio track. In other words, the selected audio tracks (e,g, selected by the selection module 204) may be processed through one or more equalization filters 206 (EQ filters). The one or more equalization filters may be configured to mimic perceptual filter banks, such as 1/3rd octave or equal ERB filters, and may be adjusted for parameters such as gain, bandwidth, and quality factor. The set of audio tracks may be fine-tuned by the equalization filter 206 to meet the audio quality metrics and the listener preferences.

Once the one or more equalization filters 206 have been applied, the processed set of audio tracks may undergo subjective listening tests. The listening tests may involve human evaluators who rate the audio tracks based on widely accepted paradigms, such as MUSHRA (Multiple Stimuli with Hidden Reference and Anchor) or MOS (Mean Opinion Score). The evaluators assess parameters like loudness, timbre, and audible distortions.

Further, a rank determiner 208 may be configured to determine ranks of the second set of audio tracks based on audio quality metrics. The audio quality metrics of the second set of audio tracks may be determined based on testing of the second set of audio tracks. The subjective listening test results may be analyzed using statistical methods, such as ANOVA (Analysis of Variance), to rank the audio tracks by a ranking module 208.

The tests based on the audio quality metrics and the listener preferences may help to identify the tracks with the least distortion and the highest audio quality. For example, the tracks performing at or above a performance threshold may be selected for the final output. The final stage of the process-flow 200 may generate a modified PCM audio waveform, e.g. the target audio 210 which may be based on selecting at least one of the second set of audio tracks such that the selected at least one of the second set of audio tracks is free from distortion. The target audio 210 may have significantly reduced rub and buzz artifacts and improved sound quality. The target audio 210 may be distortion-free, with enhanced loudness and timbre, making it suitable for high-quality playback in speaker systems.

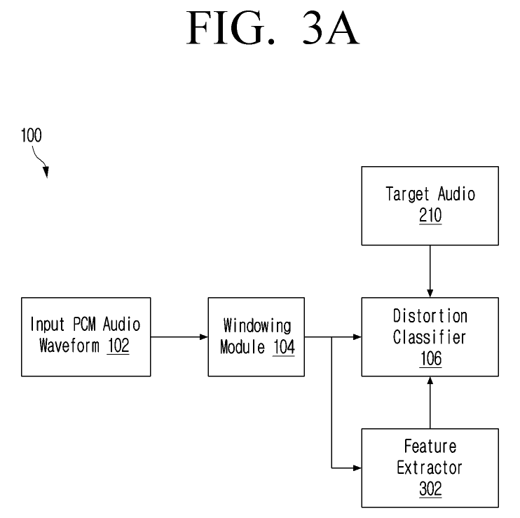

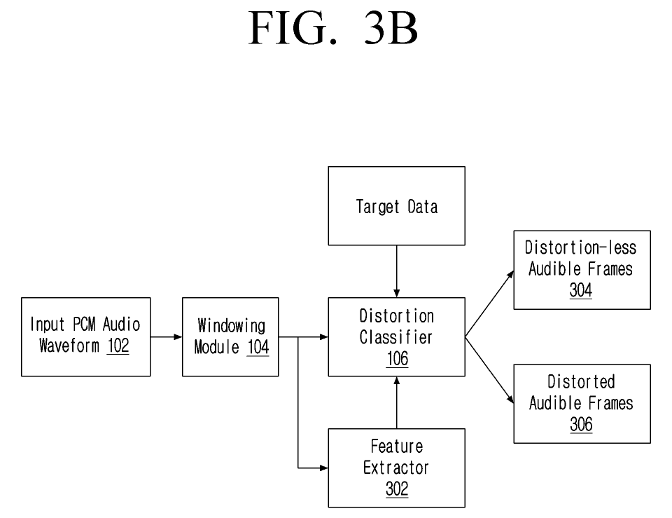

FIG. 3a and 3b illustrate a process-flow 300 for training and inference of the distortion classifier 106, according to an embodiment of the present disclosure.

Referring to FIG. 3a, the process-flow 300 begins with the input PCM audio waveform 102 to be provided as an input to the windowing module 104. The windowing module 104 may be configured to segment the input PCM audio waveform 102 into smaller, manageable chunks or frames using a windowing process. The smaller frames or the segmented frames may be configured to allow the distortion classifier 106 to analyze the signal at a finer resolution, focusing on individual time segments for distortion analysis.

Further, a feature extractor 302 may be configured to extract the signal features and the signal-based speaker characteristics. In an embodiment, the signal features may include a Short-Time Fourier Transform (STFT) and peak RMS, which may be extracted from the audio frames to capture spectral and temporal properties. Speaker features may include lumped parameter-based responses (e.g., stiffness, inductance, and force factor) and non-linear state-space responses, which may be extracted from the signal segments together with features pre-computed for speakers under test. The speaker features and the signal features may assist in determining how the audio interacts with the speaker system, particularly under stress conditions.

In an embodiment, the distortion classifier 106 may be a neural network model, such as a fully connected neural network, trained using the extracted features. The distortion classifier 106 may be a binary classifier that may be configured to determine whether each frame may be likely or not likely to cause audible distortions.

The distortion classifier 106 may be trained using synthetic data generated by simulating speaker responses under various conditions, as described in FIG. 2. The synthetic data may include distorted data and high-quality data, which may assist in ensuring robust training. The target audio may be the audio which may be generated based on synthetic data for training the distortion classifier 106.

Referring now to FIG. 3b, similar to the training, the inference process begins with the input PCM audio waveform 102 being inputted to the windowing module 104. The windowing module 104 may be configured to segment the input PCM waveform 102 into smaller frames for detailed analysis during inference.

The signal features and the speaker features may be extracted from the audio frames during inference by the feature extractor which may be the same as the feature extraction performed during training. The trained distortion classifier 106 may be used to analyze each frame. The trained distortion classifier may be configured to predict whether a frame may be likely to cause audible distortion or not by using the extracted features. The distortion classifier 106 may be configured to produce two outputs namely audible frames not leading to audible distortion 304, and audible frames leading to audible distortion 306. The audible frames not leading to audible distortion 304 may be distortion-free frames that may be be directly processed or used without correction. The audible frames leading to audible distortion 306 may be distortion-prone frames identified by the distortion classifier 106. These frames may require further processing to reduce distortions.

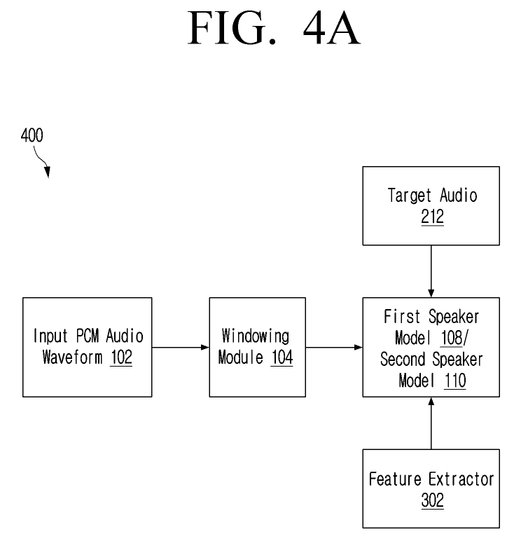

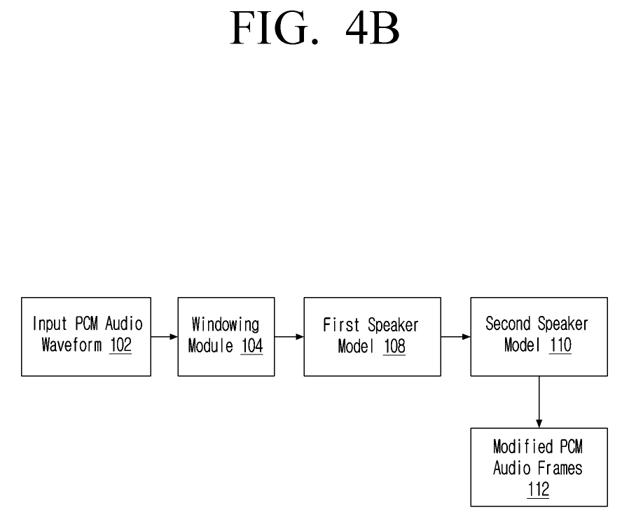

FIG. 4a and 4b illustrate a process-flow 400 for training the first speaker model 108 and the second speaker model 110, according to an embodiment of the present disclosure.

Referring to FIG. 4a, the method 400 begins with the input PCM audio waveform 102 which may be provided as an input to the windowing module 104. The windowing module 104 may be configured to segment the input PCM audio waveform 102 into smaller, manageable chunks or frames using the windowing process.

Further, the segmented audio frames may be analyzed to extract speaker features and acoustic pressure using the feature extractor 302. The features may include linear lumped parameters, such as stiffness, inductance, and force factor.

The first speaker model 108 and the second speaker model 110 may be trained using the extracted features and the target audio 212. In an embodiment, the first speaker model 108 may be trained to predict the acoustic pressure and displacement for the given input PCM audio frames 102. The first speaker model may serve as a benchmark for optimal audio playback, generating acoustic pressure for audio signals which may be free from distortion when played back over target micro-speakers. In an example, the first speaker model may be an ideal speaker model. The ideal speaker model may be trained to estimate the acoustic pressure of the identified first set of audio frames.

In an embodiment, the second speaker model 110 may be trained to generate modified PCM waveforms 112 by compensating for the distortions introduced by the speaker’s characteristics. The second speaker model 110 may adjust the speaker’s response to reduce distortion and produce the output PCM waveforms. In an example, the second speaker model 110 is an inverse speaker model. The inverse speaker model is trained to generate the first output using the estimated acoustic pressure of the identified first set of audio frames.

FIG. 4b illustrates a process-flow 400 for inferencing the first speaker model 108 and the second speaker model 110, according to an embodiment of the present disclosure.

Referring now to FIG. 4b, similar to the training, the inference process begins with the input PCM audio waveform 102 being inputted to the windowing module 104. The windowing module 104 may be configured to segment the input PCM waveform 102 into smaller frames for detailed analysis during inference.

The first speaker model 108 may be configured to receive the audio frames as input and may be configured to estimate the displacement and acoustic pressure. The step of receiving the audio frames as the input may provide a reference for the speaker behavior in an ideal, distortion-free scenario. The second speaker model or the inverse speaker model may be configured to modify the input PCM waveform 102 by applying adjustments based on the estimated displacement and acoustic pressure which may include timbre scaling and loudness scaling.

The final output (e.g., the first output) may be the modified PCM audio waveform 112 with reduced distortions and improved audio quality. The modified PCM waveform 112 may be suitable for playback through real-world speaker systems, ensuring an enhanced listener experience.

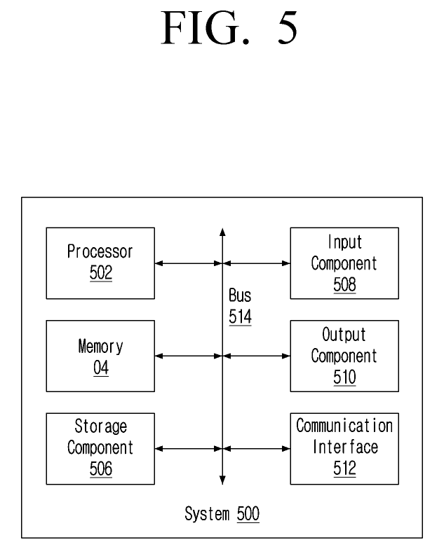

FIG. 5 illustrates a system 500 for membrane excursion control of the speaker device according to an embodiment of the present disclosure.

The system 500 includes a processor 502, a memory 504, a storage component 506, an input component 508, an output component 510, a communication interface 512, and a bus 514.

The processor 502, as used herein, may mean any type of computational circuit that may include hardware elements and software elements. The processor 502 may be embodied as a multi-core processor, a single core processor, or a combination of one or more multi-core processors and/or one or more single core processors, a distributed processing system, or the like. The processor 502 may be a Central Processing Unit (CPU) a graphics processing unit (GPU), an accelerated processing unit (APU), an application-specific integrated circuit (ASIC), or another type of processing component.

The memory 504 may include a non-transitory computer readable medium. The memory 504 may include a random-access memory (RAM), a read only memory (ROM), and/or another type of dynamic or static storage device (e.g., a flash memory, a magnetic memory, and/or an optical memory) that may store information and/or instructions for use by processor 502. The memory 504 may include machine-readable instructions which may be executable by the processor 502. These machine-readable instructions when executed by the processor 502 may cause the processor 502 to perform one or more method steps of an embodiment described above.

The storage component 506 may store information and/or software related to the operation and use of the device. For example, the storage component 506 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

The input component 508 may be configured to receive information, such as user input. For example, the input component 508 may include, but not be limited to, a touch screen display, a keyboard, a keypad, a mouse, a button, a switch, and/or a microphone. The output component 510 may be configured to convey information from the system to the user or other systems, utilizing a variety of devices and technologies tailored to specific application needs. The output component 510 may include visual output devices such as display screens (LCD, LED, OLED), projectors, and heads-up displays (HUDs) for presenting graphical or textual information. Additionally, auditory output through speakers and headphones provides audio feedback and alerts, while haptic output devices, like vibration motors in smartphones or game controllers, offer tactile feedback. Functionally, the output component may serve multiple roles, including displaying graphical user interface (GUI) elements for user interaction, delivering notifications and alerts through sound, visual indicators, or vibrations, and rendering complex data visualizations like charts and graphs for easier comprehension.

In an embodiment, the output component 510 may be configured to receive processed data from the processor 502, which may determine the information to be communicated, and the output component 510 may access memory 504 and storage component 506 to retrieve and display stored information such as documents, media files, or application states. Furthermore, the output component 510 may be configured to meet the specific requirements of different applications, such as high-resolution visual output and immersive audio for gaming systems or clear and precise data visualization and alert mechanisms for industrial control systems. Through these varied output methods, the output component 510 may ensure effective communication of information, enhancing both system functionality and user experience.

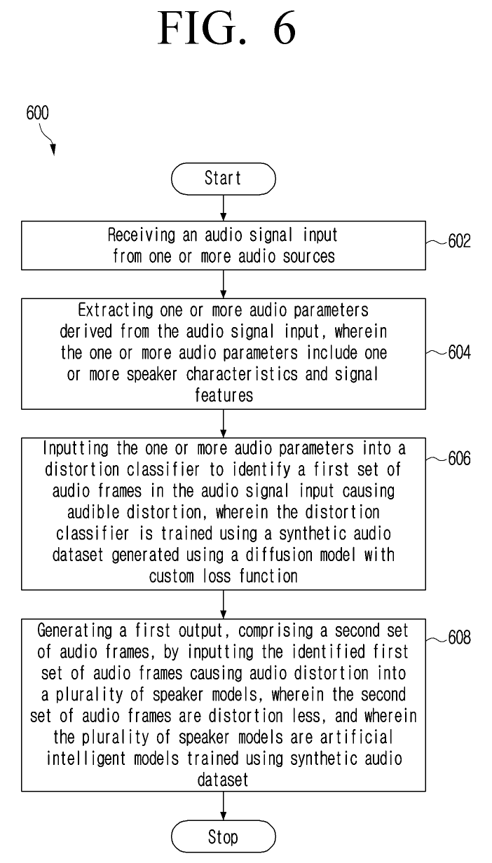

FIG. 6 illustrates a flowchart depicting a method 600 for membrane excursion control of the speaker device, according to an embodiment of the present disclosure.

At step 602, the method 600 may include receiving an audio signal input from one or more audio sources.

At step 604, the method 600 may include extracting one or more audio parameters derived from the audio signal input. The one or more audio parameters may include one or more speaker characteristics and signal features.

At step 606, the method 600 may include inputting the one or more audio parameters into a distortion classifier to identify a first set of audio frames in the audio signal input causing audible distortion. The distortion classifier may be trained using a synthetic audio dataset generated using a diffusion model with custom loss function.

At step 608, the method may include generating a first output, including a second set of audio frames, by inputting the identified first set of audio frames causing audio distortion into a plurality of speaker models. The second set of audio frames may be distortion less and the plurality of speaker models may be artificial intelligent (AI) models trained using the synthetic audio dataset.

### The present invention provides various advantages

The present invention significantly reduces audible distortions, improving clarity and richness in audio playback.

The present invention minimizes mechanical stress on the speaker diaphragm, enhancing its lifespan by controlling membrane excursion.

The integration of equalization filters allows for adjustable parameters, enabling users to customize the sound output according to their preferences.

The use of AI-based speaker models (e.g., ideal speaker model and inverse speaker model) enables intelligent compensation for distortions in real time.

The invention incorporates a the diffusion model which generates a high-quality synthetic audio dataset, reducing the reliance on large-scale real-world data collection.

While specific language has been used to describe the disclosure, any limitations arising on account of the same are not intended. As would be apparent to a person in the art, various working modifications may be made to the method in order to implement the inventive concept as taught herein.

The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed:

1. A method for membrane excursion control of an electronic apparatus, the method comprising:
receiving an audio signal input from at least one audio source;
extracting an at least one audio parameter derived from the audio signal input, wherein the at least one audio parameter comprises at least one of:at least one speaker characteristic and at least one signal feature;
inputting the at least one audio parameter into a distortion classifier to identify a first set of audio frames in the audio signal input causing audible distortion, wherein the distortion classifier is trained using a synthetic audio dataset generated using a diffusion model with a loss function; and
generating a first output, comprising a second set of audio frames, by inputting the first set of audio frames causing audio distortion into a plurality of speaker models, wherein the second set of audio frames are distortion less, and wherein the plurality of speaker models are artificial intelligent (AI) models trained using the synthetic audio dataset.

2. The method as claimed in claim 1, wherein the plurality of speaker models include at least one of a first speaker model and a second speaker model.

3. The method as claimed in claim 2, wherein generating the first output, the method comprising:
generating a second output by inputting the first set of audio frames into the first speaker model; and
generating the first output by inputting the second output to the second speaker model.

4. The method as claimed in claim 3, wherein generating the second output, the method comprising:
determining an acoustic pressure of the first set of audio frames; and
generating the second output based on the first set of audio frames, wherein the second output indicates the acoustic pressure of the first set of audio frames.

5. The method as claimed in claim 4, wherein generating the first output, the method comprising:
providing the acoustic pressure of the first set of audio frames to the second speaker model; and
generating the first output based on the acoustic pressure of the first set of audio frames, wherein the first output indicates the second set of audio frames.

6. The method as claimed in claim 1, generating the synthetic audio dataset, the method comprising:
training the diffusion model with the loss function to generate an audio waveform with reduced distortion, wherein the loss function is based on differentiable functions corresponding to one or more audio quality metrics; and
generating the synthetic audio dataset using the diffusion model.

7. The method as claimed in claim 1, wherein the training of the diffusion model with the loss function comprising:
receiving a first set of audio tracks by the diffusion model;
selecting a second set of audio tracks based on at least one audio quality metric derived from the loss function such that the second set of audio tracks is free from distortion in terms of sound quality;
inputting the second set of audio tracks to a filter, wherein the filter is configured to emulate a perceptual filter bank-inspired filter, with filter parameters adjustable by listeners;
determining ranks of the second set of audio tracks based on the at least one audio quality metric, wherein the at least one audio quality metric of the second set of audio tracks are determined based on testing of the second set of audio tracks; and
selecting at least one of the second set of audio tracks such that the selected at least one of the second set of audio tracks is free from distortion.

8. The method as claimed in claim 2, wherein the first speaker model is an ideal speaker model trained to estimate a first acoustic pressure of the first set of audio frames, and wherein the second speaker model is an inverse speaker model trained to generate the first output using the first acoustic pressure of the first set of audio frames.

9. An electronic apparatus for controlling membrane excursion, comprises:
a memory configured to store executable instructions;
at least one processor coupled to the memory and configured to execute the instructions to cause the electronic apparatus to:
receive an audio signal input from at least one audio source;
extract at least one audio parameter derived from the audio signal input, wherein the at least one audio parameter comprises at least one of: at least one speaker characteristic and at least one signal feature;
input the at least one audio parameter into a distortion classifier to identify a first set of audio frames in the audio signal input causing audible distortion, wherein the distortion classifier is trained using a synthetic audio dataset generated using a diffusion model with a loss function; and
generate a first output, comprising a second set of audio frames, by inputting the first set of audio frames causing audio distortion into a plurality of speaker models, wherein the second set of audio frames are distortion less, and wherein the plurality of speaker models are artificial intelligent (AI) models trained using the synthetic audio dataset.

10. The electronic apparatus of claim 9, wherein the plurality of speaker models include at least one of a first speaker model and a second speaker model.

11. The electronic apparatus of claim 10, wherein the at least one processor is further configured to cause the electronic apparatus to:
generate a second output by inputting the first set of audio frames into the first speaker model; and
generate the first output by inputting the second output to the second speaker model.

12. The electronic apparatus of claim 11, wherein the at least one processor is further configured to cause the electronic apparatus to:
determine an acoustic pressure of the first set of audio frames; and
generate the second output based on the first set of audio frames, wherein the second output indicates the acoustic pressure of the first set of audio frames.

13. The electronic apparatus of claim 12, wherein the at least one processor is further configured to cause the electronic apparatus to:
provide the acoustic pressure of the first set of audio frames to the second speaker model; and
generate the first output based on the acoustic pressure of the first set of audio frames, wherein the first output indicates the second set of audio frames.

14. The electronic apparatus of claim 9, wherein the at least one processor is further configured to cause the electronic apparatus to:
train the diffusion model with the loss function to generate an audio waveform with reduced distortion, wherein the loss function is based on differentiable functions associated with at least one audio quality metric; and
generate the synthetic audio dataset using the diffusion model.

15. The electronic apparatus of claim 9, wherein the at least one processor is further configured to cause the electronic apparatus to:
receive a first set of audio tracks by the diffusion model;
select a second set of audio tracks based on at least one audio quality metric derived from the loss function such that the second set of audio tracks is free from distortion in terms of sound quality;
input the second set of audio tracks to a filter, wherein the filter is designed to emulate a perceptual filter bank-inspired filter, with filter parameters adjustable by listeners;
determine ranks of the second set of audio tracks based on the at least one audio quality metric, wherein the at least one audio quality metric of the second set of audio tracks are determined based on testing of the second set of audio tracks; and
select at least one of the second set of audio tracks such that the selected at least one of the second set of audio tracks is free from distortion.

16. A non-transitory computer readable medium storing instructions, the instructions configured to cause one or more processors of a computer to perform a method for membrane excursion control of an electronic apparatus, the method comprising:
receiving an audio signal input from at least one audio source;
extracting an at least one audio parameter derived from the audio signal input, wherein the at least one audio parameter comprises at least one of:at least one speaker characteristic and at least one signal feature;
inputting the at least one audio parameter into a distortion classifier to identify a first set of audio frames in the audio signal input causing audible distortion, wherein the distortion classifier is trained using a synthetic audio dataset generated using a diffusion model with a loss function; and
generating a first output, comprising a second set of audio frames, by inputting the first set of audio frames causing audio distortion into a plurality of speaker models, wherein the second set of audio frames are distortion less, and wherein the plurality of speaker models are artificial intelligent (AI) models trained using the synthetic audio dataset.

17. The method as claimed in claim 1, wherein the plurality of speaker models include at least one of a first speaker model and a second speaker model.

18. The method as claimed in claim 1, generating the synthetic audio dataset, the method comprising:
training the diffusion model with the loss function to generate an audio waveform with reduced distortion, wherein the loss function is based on differentiable functions associated with one or more audio quality metrics; and
generating the synthetic audio dataset using the diffusion model.

19. The method as claimed in claim 1, wherein the training of the diffusion model with the loss function comprising:
receiving a first set of audio tracks by the diffusion model;
selecting a second set of audio tracks based on at least one audio quality metric derived from the loss function such that the second set of audio tracks is free from distortion in terms of sound quality;
inputting the second set of audio tracks to a filter, wherein the filter is designed to emulate a perceptual filter bank-inspired filter, with filter parameters adjustable by listeners;
determining ranks of the second set of audio tracks based on the at least one audio quality metric, wherein the at least one audio quality metric of the second set of audio tracks are determined based on testing of the second set of audio tracks; and
selecting at least one of the second set of audio tracks such that the selected at least one of the second set of audio tracks is free from distortion.

20. The method as claimed in claim 2, wherein the first speaker model is an ideal speaker model trained to estimate a first acoustic pressure of the first set of audio frames, and
wherein the second speaker model is an inverse speaker model trained to generate the first output using the first acoustic pressure of the first set of audio frames.
